(19) United States
(12) Patent Application Publication
(10) Pub. No.: US 2019/0128446 A1
(43) Pub. Date: May 2, 2019

(54) POOL POLE CLAMP ASSEMBLY

(71) Applicant: Pam Harms, Grand Haven, MI (US)

(72) Inventor: Pam Harms, Grand Haven, MI (US)

(21) Appl. No.: 15/802,857

(22) Filed: Nov. 3, 2017

Related U.S. Application Data
(63) Continuation-in-part of application No. 29/624,313, filed on Oct. 31, 2017.
(60) Provisional application No. 62/580,142, filed on Nov. 1, 2017.

(51) Int. Cl. F16L 3/04; E04H 4/16; E04H 4/14

(52) U.S. Cl. CPC F16L 3/04; E04H 4/1609; E04H 4/14; E04H 4/16

(57) ABSTRACT

A clamp assembly adapted for releasably retaining a pool pole including a first arm that is displaceable along a first axis (X), a second arm, that is displaceable along the same first axis (X) as the first arm, a first leg, wherein an upper end of the first leg contacts and/or forms part of a lower end of the first arm, a second leg, wherein an upper end of the second leg contacts and/or forms part of a lower end of the second arm, and a primary support member, wherein a first end of the primary support member contacts and/or forms part of an upper end of the first leg and wherein the second end of the primary support member contacts and/or forms part of an upper end of the second leg.

### CROSS-REFERENCE TO RELATED APPLICATIONS

This application claims the benefit of U.S. Provisional Patent Application Ser. No. 62/580,142, filed Nov. 1, 2017, entitled “Pool Pole Clamp Assembly” and U.S. Design Patent Application Ser. No. 29/624,313, filed Oct. 31, 2017, entitled “Pool Pole Clamp Assembly”—which are hereby incorporated herein by reference in their entirety, including all references and appendices cited therein.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

### 1. Field of the Invention

The present invention relates in general to a clamp assembly, and, more particularly, to a bi-arm clamp assembly which is releasably securable to a plurality of telescoping and non-telescoping pool poles having accessories (e.g., brushes, nets, skimmers, vacuum cleaners, etcetera) attached thereto.

### 2. Background Art

Clamp assemblies for use in numerous applications have been known in the art for years, and are the subject of a plurality of patents including, for example: U.S. Pat. No. 4,660,870 entitled “Clamp,” U.S. Pat. No. 4,826,215 entitled “Clamp,” U.S. Pat. No. 4,893,801 entitled “Clamp,” U.S. Pat. No. 5,423,831 entitled “Clamp,” U.S. Pat. No. 5,863,021 entitled “Multiple Fastener,” U.S. Pat. No. 5,898,975 entitled “Multi-Purpose Holder,” U.S. Pat. No. 7,229,055 entitled “Hook Holder For Holding Scaffolding Elements to a Scaffold,” U.S. Pat. No. 7,490,797 entitled “Portable Supporting Apparatus,” and U.S. Pat. No. 7,490,802 entitled “Beam Clamp”—all of which are hereby incorporated herein by reference in their entirety including the references cited therein.

U.S. Pat. No. 4,660,870 appears to disclose a band that is discontinuous circumferentially and placeable on an object to be clamped in transverse direction. Toggle locking means releasably lock the ends of the band together on the object. In one form the band is made in parts hinged together, and in another, it is a single piece of flexible material. The clamp, in another form includes an inner band forming a sealing gasket. In still another form, a repair band is included, which is applied to the object, and when the clamp is removed, the repair band remains as a unitary repair component on the object.

U.S. Pat. No. 4,826,215 appears to disclose a clamp for securing a hose connection. The clamp is a cylindrical shell which encases a hose connection and secures the connection from being disconnected by ordinary means.

U.S. Pat. No. 4,893,801 appears to disclose a hand-held clamp which is operable by one hand. The clamp includes a stationary jaw and a movable jaw carried on elongated support arms. A pressure arm is attached to the movable jaw and is advanced by a ratchet mechanism operated by the hand holding the clamp.

U.S. Pat. No. 5,423,831 appears to disclose a clamp which has a pair of arms having their inner ends joined by a hinge and their outer ends connected by a locking device. The device comprises one member having a body with a transverse groove therein and a second member comprising a tongue with a hook which engages in the groove. The first mentioned member further comprises a cross-bar spaced away from and above the groove and the tongue is capable of being inserted between the cross-bar and the body. The tongue also has a projection to engage the cross-bar when the hook engages in the groove.

U.S. Pat. No. 5,863,021 appears to disclose a holding device that has a first arm with a first end and a second end and an intermediate portion extending between the first and second ends and an attachment portion disposed in the intermediate portion. A second arm also has first and second ends, an intermediate portion extending between the first and second ends and an attachment portion disposed in the intermediate portion. The first and second arms are pivotally attached to one another at the attachment portions thereof. A third arm has first and second end portions and an intermediate portion extending therebetween. The third arm portion is pivotally attached at an attachment portion to the intermediate portion of the second arm. A biasing system is coupled to the first, second and third arms and biases the first ends of the first and second arms toward one another and the second ends of the second and third arms toward one another.

U.S. Pat. No. 5,898,975 appears to disclose a multi-purpose holder with a flexible block having a guide surface for securement and for attachment to a variety of surfaces, including similar surfaces of others of the same multi-purpose holder and as a guide for a strap and an opposite gripping surface with a central, wide V-groove and parallel, narrow side V-grooves adjacent wings forming a continuation of the gripping surface of the block and having gripping surfaces thereon to engage an object positioned in the central, wide V-groove as the strap is tightened around the flexible block, the wings and the object.

U.S. Pat. No. 7,229,055 appears to disclose a holding hook for a mutual blocking position retaining of a first type of scaffold elements and a second type of scaffold elements in a scaffold and consisting of a holding part that relative to an axis is pivotally applied to a fixed holding part. This pivotally applied holding part is shiftable between a holding position in which the pivoted holding part is blocked and a releasing position for the scaffold elements. The pivoted holding part is also displaceable along the axis and is equipped with a blocking part, that at a first axial displacement position in the blocking position of the holding hook blocks the pivoted holding part in its holding position by displacement towards a fixed blocking surface in the fixed holding part. In a second axial displacement position outside the blocking surface, the pivoted holding part is allowed to be shifted to a releasing position.

U.S. Pat. No. 7,490,797 appears to disclose a portable supporting apparatus for a portable multimedia device that includes a support housing and a mounting arrangement. The support housing includes a multimedia connector for detachably connecting with the portable multimedia device. The mounting arrangement is provided underneath the support housing, and includes a plurality of supporting legs, each having a predetermined shape, pivotally and downwardly extended from the support housing, wherein supporting legs are adapted to move between an idle position, and a mounting position where each of the supporting legs is pivotally moved to form a predetermined angle of inclination with respect to the support housing so as to bias against an external object for frictionally retaining a position of the support housing with respect to the external object, such that the portable multimedia device is capable of being securely supported by the external object through the portable supporting apparatus.

U.S. Pat. No. 7,490,802 appears to disclose a beam clamp having a C-shaped clamp body, which has a threaded through hole on the top side and two parallel vertical cuts on the middle, and a hanging plate, which extends downwardly from the clamp body and suspending between the two parallel cuts and has a hanging hole and a plurality of forwardly and backwardly curved and threaded semicircular flanges alternatively disposed at different elevations for the hanging of a heavy object.

While the above-identified patents do appear to disclose clamps for numerous different applications, their configurations remain non-desirous and/or problematic inasmuch as, among other things, none of the above-identified clamp assemblies appear to be configured to effectively retain a pool pole adjacent to a pool as is disclosed herein.

It is therefore an object of the present invention to provide a bi-arm clamp assembly as is disclosed herein, which, among other things, remedies detriments and/or complications associated with the use of conventional clamp assemblies. It is therefore a further object of the present invention to provide a clamp assembly which, among other things, comprises displaceable bi-arms which are biased inwardly into a closed position to releasably retain a pool pole positioned adjacent to a pool, wherein the clamp assembly includes both primary and secondary cross or horizontal support members. Such a clamp is adapted to releasably secure pool poles having various attachments and/or accessories including, but not limited to, wall/floor brushes, leaf nets, skimmers, vacuum cleaners, etcetera.

These and other objects of the present invention will become apparent in light of the present specification, claims, and drawings.

### SUMMARY OF THE INVENTION

The present invention is directed to a clamp assembly adapted for releasably retaining a pool pole, comprising, consisting essentially of, and/or consisting of: (a) a first arm, wherein the first arm comprises an inner surface, an outer surface, an upper end, and a lower end, and wherein the first arm is displaceable along a first axis (X); (b) a second arm, wherein the second arm comprises an inner surface, an outer surface, an upper end, and a lower end, and wherein the second arm is displaceable along the same first axis (X) as the first arm; (c) a first leg, wherein the first leg comprises an inner surface, an outer surface, an upper end, and a lower end, wherein the upper end of the first leg contacts and/or forms part of the lower end of the first arm, and wherein the first leg is adapted to engage a surface adjacent to a pool; (d) a second leg, wherein the second leg comprises an inner surface, an outer surface, an upper end, and a lower end, wherein the upper end of the second leg contacts and/or forms part of the lower end of the second arm, and wherein the second leg is adapted to engage a surface adjacent to a pool; and (e) a primary support member, wherein the primary support member comprises a front surface, a rear surface, a top surface, a bottom surface, a first end, and a second end, wherein the first end of the primary support member contacts and/or forms part of the upper end of the first leg and wherein the second end of the primary support member contacts and/or forms part of the upper end of the second leg.

In a preferred embodiment of the present invention, the first arm and the second arm are substantially arcuate in shape.

In another preferred embodiment of the present invention, at least a portion of the inner surfaces of the first and/or second arms are concave.

In yet another preferred embodiment of the present invention, at least a portion of the outer surfaces of the first and second arms are concave and spaced apart an equal distance from the inner surfaces of the first and second arms.

In another aspect of the present invention, at least a portion of the top surface and the bottom surface of the primary support member are orthogonally concave relative to at least a portion of the inner and outer surfaces of the first and second arms.

In a preferred embodiment of the present invention, the inner surfaces and/or the outer surfaces of the lower ends of the first and/or second legs are planar.

In another preferred embodiment of the present invention, the clamp assembly further includes a secondary support member. Preferably, the secondary support member is positioned above the primary support member. Yet more preferably, the secondary support member emanates contiguously and orthogonally from the primary support member, and optionally includes at least one reinforcing rib member.

In yet another preferred embodiment of the present invention, the lower end of the first leg and the lower end of the second leg include stabilizing weights positioned therein.

In yet another aspect of the present invention, the lower end of the first leg and the lower end of the second leg are preferably coated with a rubberized and/or gripping agent.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted. It will be further understood that the invention is not necessarily limited to the particular embodiments illustrated herein.

The invention will now be described with reference to the drawings wherein:

FIG. 1 is a front perspective view of a clamp assembly constructed in accordance with the present invention;

FIG. 2 is a front view of the clamp assembly of FIG. 1;

FIG. 3 is a top plan view of the clamp assembly of FIG. 1;

FIG. 4 is a bottom view of the clamp assembly of FIG. 1;

FIG. 5 is a side view of the clamp assembly of FIG. 1; and

FIG. 6 is a front view of an alternative embodiment of a clamp assembly constructed in accordance with the present invention.

### DETAILED DESCRIPTION OF THE INVENTION

While this invention is susceptible of embodiment in many different forms, there is shown in the drawings and described herein in detail several specific embodiments with the understanding that the present disclosure is to be considered as an exemplification of the principles of the invention and is not intended to limit the invention to the embodiments illustrated.

It will be understood that like or analogous elements and/or components, referred to herein, may be identified throughout the drawings by like reference characters. In addition, it will be understood that the drawings are merely schematic representations of one or more embodiments of the invention, and some of the components may have been distorted from their actual scale for purposes of pictorial clarity.

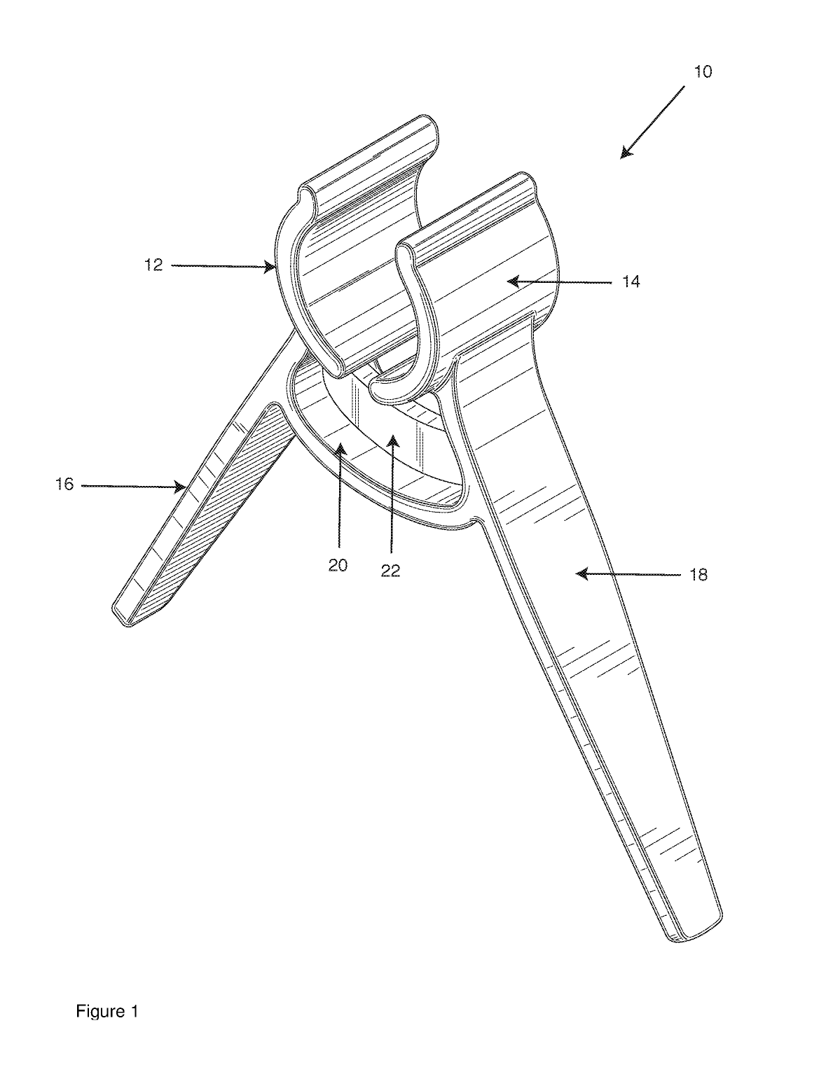

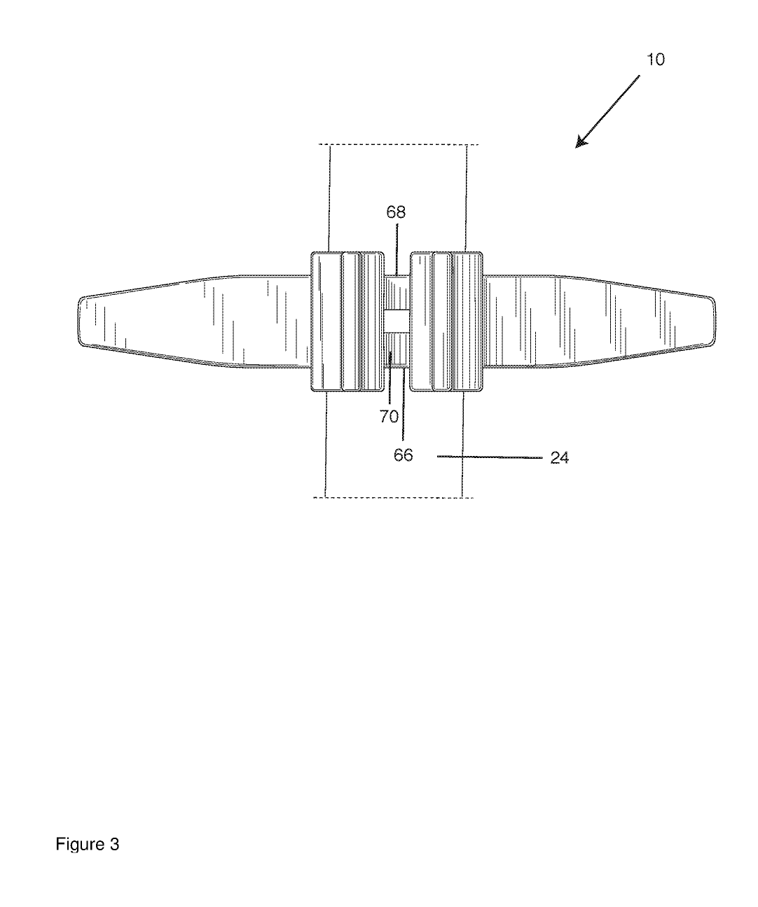

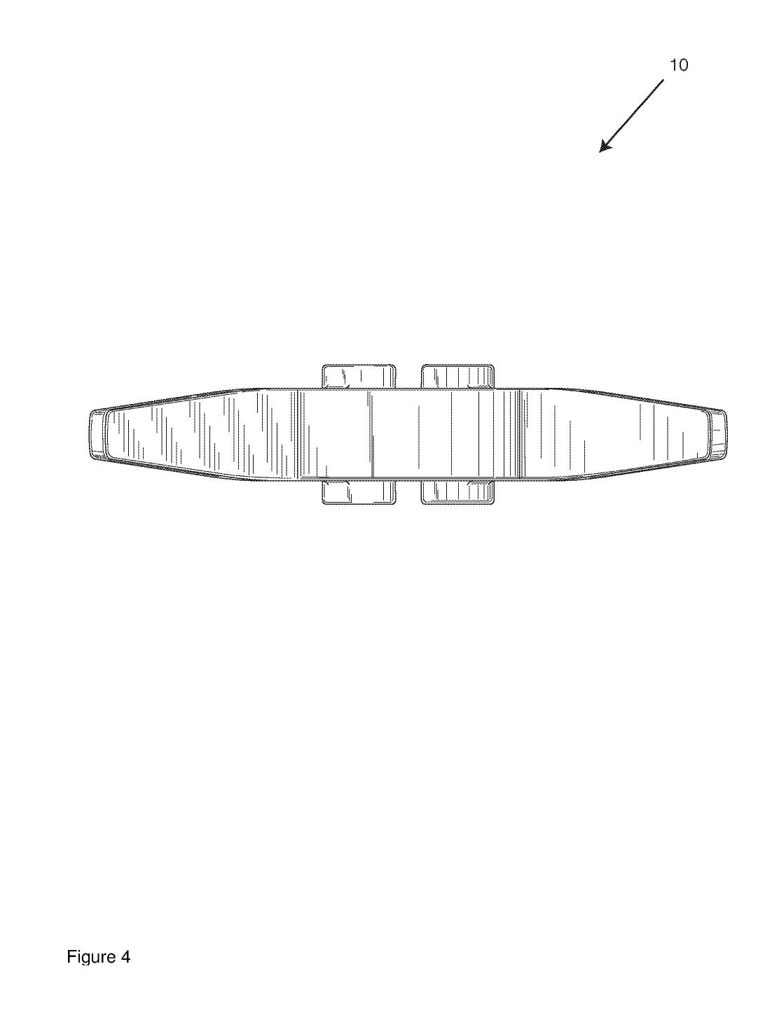

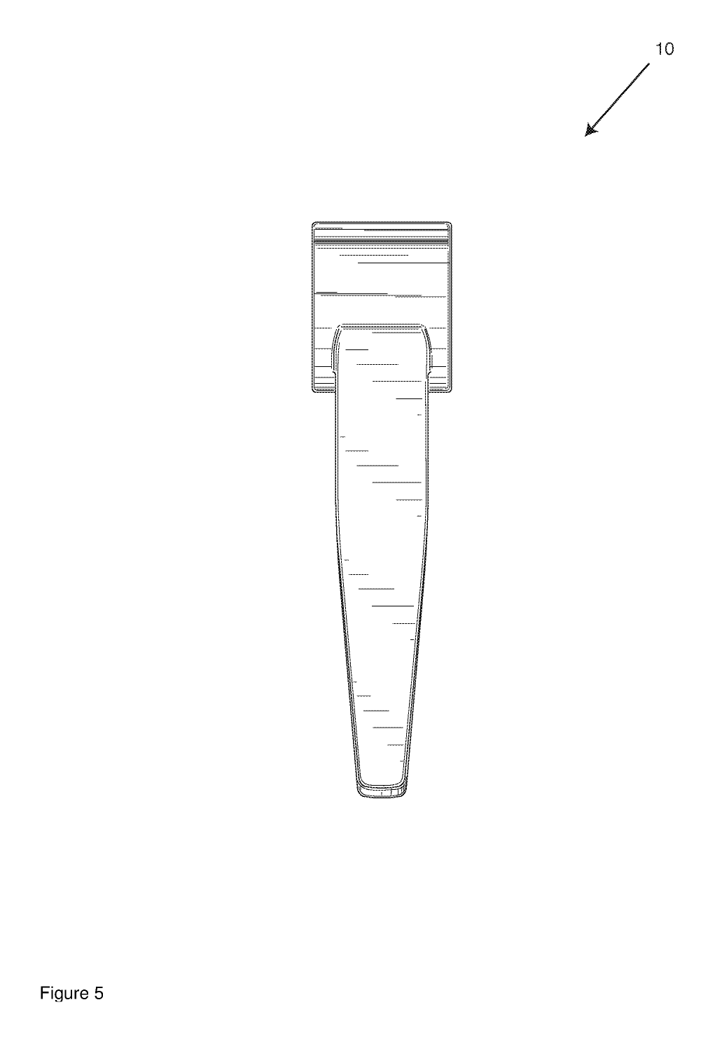

Referring now to the drawings, and to FIGS. 1-5 in particular, a first embodiment of clamp assembly 10 is shown which generally comprises first arm 12, second arm 14, first leg 16, second leg 18, and primary support member 20, and optional secondary support member 22. Clamp assembly 10 is adapted to receive and releasably hold at least a portion of an object, such as telescoping and/or non-telescoping pool pole 24 (See FIG. 3). Pool pole 24 may include and/or be associated with one or more heads and/or accessories, such as brushes, nets, skimmers, vacuum cleaners—just to name a few.

Clap assembly 10 may be fabricated from any one of a number of resilient materials such as a metal, an alloy, a polymer, a natural and/or synthetic resin, a natural product such as wood, a composite, or any combination thereof. Clamp assembly 10 may be fabricated from a single, unitary piece of material, or, alternatively may be fabricated from a plurality of pieces of material.

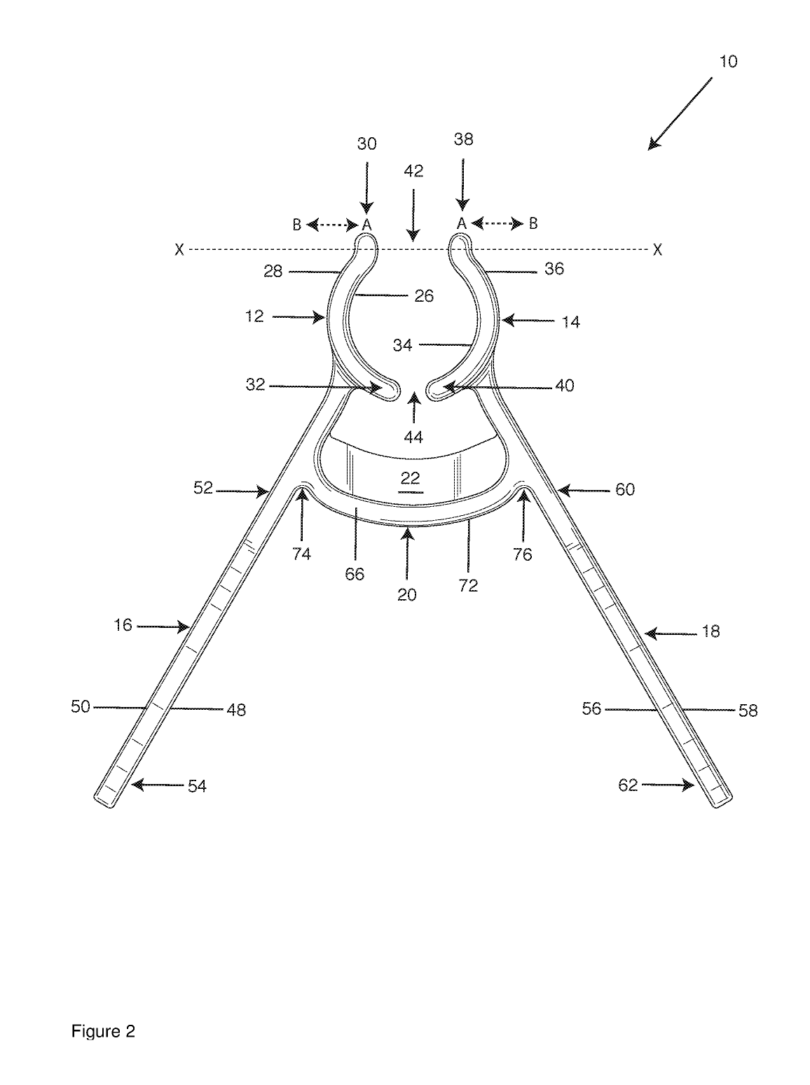

First arm 12 of clamp assembly 10 preferably includes inner surface 26, outer surface 28, upper end 30, and lower end 32. As is best shown in FIG. 2, first arm 12 is displaceable along a first axis (X) from an initial, undisplaced position (A) to a second, displaced positon (B) upon insertion of a pool pole.

Second arm 14 of clamp assembly 10 preferably includes inner surface 34, outer surface 36, upper end 38, and lower end 40. As is best shown in FIG. 2, second arm 14 is displaceable along a first axis (X) from an initial, undisplaced position (A) to a second, displaced positon (B) upon insertion of a pool pole. It will be understood that first arm 12 and second arm 14 cooperatively interact to releasably retain pool pole 24.

In a preferred embodiment of the present invention, first arm 12 and second arm 14 are substantially arcuate in shape and generally conform to the external peripheral geometry of a conventional pool pole.

The upper and lower ends of first arm 12 and second arm 14 are preferably disconnected and/or non-continuous so as to form upper and lower apertures 42 and 44, respectively. These apertures cooperatively enable the releasable securement of a plurality of sized pool poles.

In another aspect of the present invention, at least a portion of inner surface 26 of first arm 12 is preferably concave. More preferably, a majority or at least fifty percent of inner surface 26 is concave.

In yet another aspect of the present invention, at least a portion of inner surface 34 of second arm 14 is preferably concave. More preferably, a majority or at least fifty percent of inner surface 34 is concave.

Referring now to FIGS. 1 and 2, at least a portion, and preferably a majority, of outer surface 28 of first arm 12 is preferably concave and spaced apart an equal distance from inner surface 26 of first arm 12.

Referring also to FIGS. 1 and 2, at least a portion, and preferably a majority, of outer surface 36 of second arm 14 is preferably concave and spaced apart an equal distance from inner surface 34 of second first arm 14.

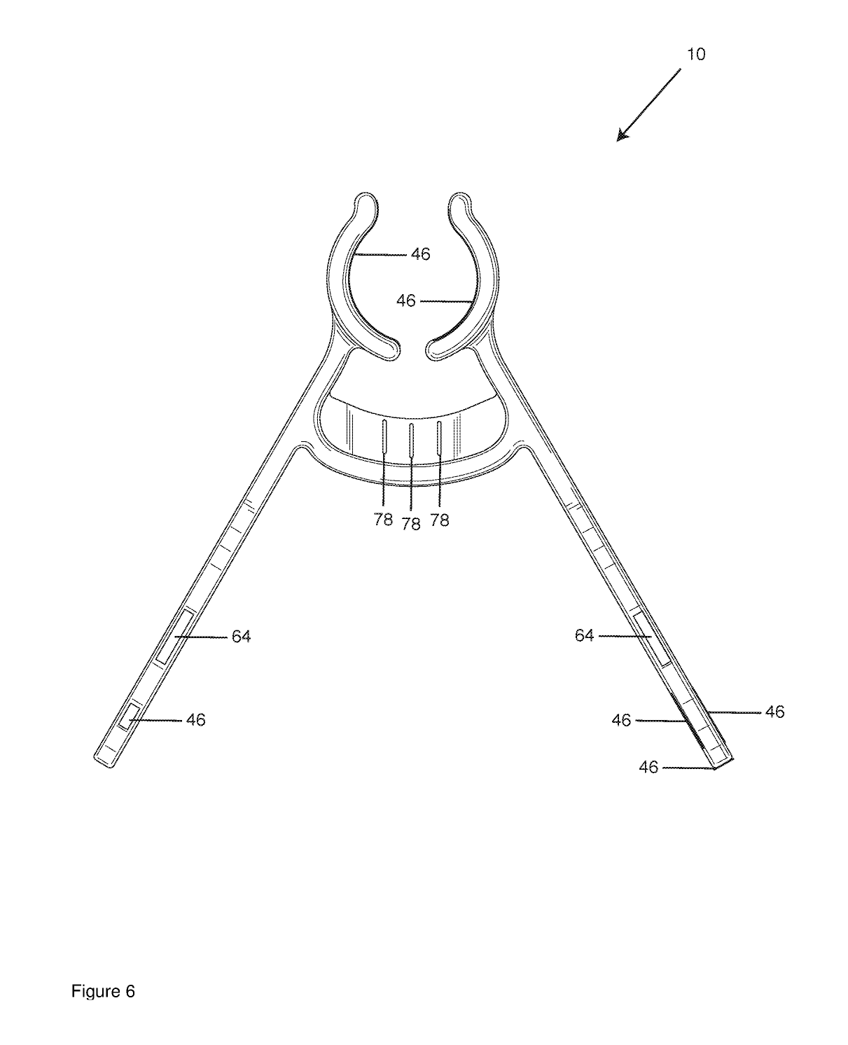

As is best shown in FIG. 6, inner surface 26 of first arm 12 and/or inner surface 34 of second arm 14 may include an overcoat/gripping layer 46.

In accordance with the present invention, overcoat layer 46 is preferably fabricated from a thermoplastic elastomer, including, but not limited to, a styrenic block copolymer, a thermoplastic olefin, an elastomeric alloy, a thermoplastic polyurethane, a thermoplastic copolyester, a thermoplastic polyamide and/or one or more elastomeric materials, including, but not limited to, natural polyisoprenes, synthetic polyisoprenes, polybutadienes, chloroprene rubbers, butyl rubbers, halogenated butyl rubbers, styrene-butadiene rubbers, nitrile rubbers, hydrogenated nitrile rubbers, ethylene propylene rubbers, ethylene propylene diene rubbers, epichlorohydrin rubbers, polyacrylic rubbers, silicone rubbers, fluorosilicone rubbers, fluoroelastomers, perfluoroelastomers, polyether block amides, chlorosulfonated, ethylene-vinyl acetates, resilins, elastins, a polysulfide rubbers, elastolefins, and combinations thereof.

First leg 16 preferably includes inner surface 48, outer surface 50, upper end 52, and lower end 54. Upper end 52 of first leg 16 preferably contacts and/or forms part of lower end 32 of first arm 12. First leg 16 is adapted to engage a surface (e.g., a generally horizontal pool deck and/or walkway) adjacent to a pool so that the entire pool pole does not slip and/or fall into the water and become submerged.

Second leg 18 preferably includes inner surface 56, outer surface 58, upper end 60, and lower end 62. Upper end 60 of second leg 18 preferably contacts and/or forms part of lower end 40 of second arm 14. Second leg 18 is adapted to engage a surface (e.g., a generally horizontal pool deck and/or walkway) adjacent to a pool so that the entire pool pole does not slip and/or fall into the water and become submerged.

Referring now to FIGS. 1-5, first and second legs 16 and 18, respectively, preferably include planar and/or substantially planar surfaces (e.g., inner, outer, front, and back) generally below primary support member 20.

As is best shown in FIG. 6, and in one aspect of the present invention, the lower ends of first leg 16 and/or second leg 18 preferably include stabilizing weights 64 positioned within reservoir/slots therein.

Referring once again to FIG. 6, the lower ends of first leg 16 and/or second leg 18 may include an overcoat/gripping layer 46.

In accordance with the present invention, overcoat layer 46, associated with first leg 16 and/or second leg 18, is preferably fabricated from a thermoplastic elastomer, including, but not limited to, a styrenic block copolymer, a thermoplastic olefin, an elastomeric alloy, a thermoplastic polyurethane, a thermoplastic copolyester, a thermoplastic polyamide and/or one or more elastomeric materials, including, but not limited to, natural polyisoprenes, synthetic polyisoprenes, polybutadienes, chloroprene rubbers, butyl rubbers, halogenated butyl rubbers, styrene-butadiene rubbers, nitrile rubbers, hydrogenated nitrile rubbers, ethylene propylene rubbers, ethylene propylene diene rubbers, epichlorohydrin rubbers, polyacrylic rubbers, silicone rubbers, fluorosilicone rubbers, fluoroelastomers, perfluoroelastomers, polyether block amides, chlorosulfonated, ethylene-vinyl acetates, resilins, elastins, a polysulfide rubbers, elastolefins, and combinations thereof. It will be understood that overcoat layer 46 may be associated with one or more parts and/or components of clamp assembly 10 via, for example, etch coating, dip coating, spin coating, brush coating and/or spray coating—including, but not limited to, cold spraying, thermal spraying, high velocity spraying (e.g., supersonic), low velocity spraying (e.g., subsonic), triboelectric discharge kinetic spraying and other similar processes.

As is best shown in FIGS. 1-5, primary support member 20 of clamp assembly 10 preferably includes front surface 66, rear surface 68, top surface 70 (which is generally planar when clamp assembly 10 is void of secondary support member 22), bottom surface 72, first end 74, and second end 76. First end 74 of primary support member 20 preferably contacts and/or forms part of upper end 52 of first leg 16, and second end 76 of primary support member 20 preferably contacts and/or forms part of upper end 60 of second leg 18.

As is best shown in FIG. 2, at least a portion, and preferably a majority, of top surface 70 and bottom surface 72 of primary support member 20 are orthogonally concave relative to at least a portion, and preferably a majority, of inner surfaces 26 and 34, and outer surfaces 28 and 36 of first and second arms 12 and 14, respectively.

In one embodiment of the present invention, clamp assembly 10 includes secondary support member 22 which is preferably positioned above (e.g., proximate the first and second arms) primary support member 20. In this embodiment, secondary support member 22 preferably emanates contiguously and orthogonally from primary support member 20.

As is best shown in FIG. 6, secondary support member 22 preferably includes one or more rib members 78. Rib members 78 provide reinforcement to the secondary support member when a pool pole is being inserted into clamp assembly 10.

In operation, pool pole 24 is releasably inserted into the arms of clamp assembly 10. Once inserted, pool pole 24 may be positioned onto a substrate or surface positioned generally adjacent to the pool. Clamp assembly 10 enables a user to position pool pole 24 next to and/or partially in the pool without becoming fully submerged.

The foregoing description merely explains and illustrates the invention and the invention is not limited thereto except insofar as the appended claims are so limited, as those skilled in the art who have the disclosure before them will be able to make modifications without departing from the scope of the invention.

What is claimed and desired to be secured by Letters Patent of the United States is:

1. A clamp assembly adapted for releasably retaining a pool pole, comprising:
a first arm, wherein the first arm comprises an inner surface, an outer surface, an upper end, and a lower end, and wherein the first arm is displaceable along a first axis (X),
a second arm, wherein the second arm comprises an inner surface, an outer surface, an upper end, and a lower end, and wherein the second arm is displaceable along the same first axis (X) as the first arm;
a first leg, wherein the first leg comprises an inner surface, an outer surface, an upper end, and a lower end, wherein the upper end of the first leg contacts and/or forms part of the lower end of the first arm, and wherein the first leg is adapted to engage a surface adjacent to a pool;
a second leg, wherein the second leg comprises an inner surface, an outer surface, an upper end, and a lower end, wherein the upper end of the second leg contacts and/or forms part of the lower end of the second arm, and wherein the second leg is adapted to engage a surface adjacent to a pool; and
a primary support member, wherein the primary support member comprises a front surface, a rear surface, a top surface, a bottom surface, a first end, and a second end, wherein the first end of the primary support member contacts and/or forms part of the upper end of the first leg and wherein the second end of the primary support member contacts and/or forms part of the upper end of the second leg.

2. The clamp assembly according to claim 1, wherein at least a portion of the inner surface of the first arm is concave.

3. The clamp assembly according to claim 2, wherein at least a portion of the inner surface of the second arm is concave.

4. The clamp assembly according to claim 3, wherein at least a portion of the outer surface of the first arm is concave and spaced apart an equal distance from the inner surface of the first arm.

5. The clamp assembly according to claim 4, wherein at least a portion of the outer surface of the second arm is concave and spaced apart an equal distance from the inner surface of the second arm.

6. The clamp assembly according to claim 5, wherein at least a portion of the top surface and the bottom surface of the primary support member are orthogonally concave relative to at least a portion of the inner and outer surfaces of the first and second arms.

7. The clamp assembly according to claim 6, wherein the inner surface and the outer surface of the lower end of the first leg are planar.

8. The clamp assembly according to claim 7, wherein the inner surface and the outer surface of the lower end of the second leg are planar.

9. The clamp assembly according to claim 8, further comprising a secondary support member.

10. The clamp assembly according to claim 9, wherein the secondary support member is positioned above the primary support member.

11. The clamp assembly according to claim 10, wherein the secondary support member emanates contiguously and orthogonally from the primary support member.

12. The clamp assembly according to claim 11, wherein the secondary support member includes at least one reinforcing rib.

13. The clamp assembly according to claim 12, wherein the lower end of the first leg and the lower end of the second leg include stabilizing weights positioned therein.

14. The clamp assembly according to claim 13, wherein the lower end of the first leg and the lower end of the second leg are coated with a rubberized and/or gripping agent.

15. The clamp assembly according to claim 14, wherein the first arm and the second arm are substantially arcuate in shape.

16. A clamp assembly adapted for releasably retaining a pool pole in combination with a pool pole, consisting of:
a clamp assembly; and
a first arm, wherein the first arm comprises an inner surface, an outer surface, an upper end, and a lower end, and wherein the first arm is displaceable along a first axis (X),
a second arm, wherein the second arm comprises an inner surface, an outer surface, an upper end, and a lower end, and wherein the second arm is displaceable along the same first axis (X) as the first arm;
a first leg, wherein the first leg comprises an inner surface, an outer surface, an upper end, and a lower end, wherein the upper end of the first leg contacts and/or forms part of the lower end of the first arm, and wherein the first leg is adapted to engage a surface adjacent to a pool;
a second leg, wherein the second leg comprises an inner surface, an outer surface, an upper end, and a lower end, wherein the upper end of the second leg contacts and/or forms part of the lower end of the second arm, and wherein the second leg is adapted to engage a surface adjacent to a pool;
a primary support member, wherein the primary support member comprises a front surface, a rear surface, a top surface, a bottom surface, a first end, and a second end, wherein the first end of the primary support member contacts and/or forms part of the upper end of the first leg and wherein the second end of the primary support member contacts and/or forms part of the upper end of the second leg; and
a secondary support member, wherein the secondary support member emanates contiguously and orthogonally from the primary support member; and
a pool pole releasably secured within the first and second arms of the clamp assembly.
